(19) United States
(12) Patent Application Publication
(10) Pub. No.: US 2015/0026795 A1
(43) Pub. Date: Jan. 22, 2015

(54) METHOD AND SYSTEM FOR EXTENDING THE SIGN-IN PROCESS FOR ACCESSING COMPUTER SYSTEMS

(71) Applicant: Mikhail Fleysher, (US)

(72) Inventor: Mikhail Fleysher, Closter, NJ (US)

(73) Assignee: Mikhail Fleysher, Closter, NJ (US)

(21) Appl. No.: 13/891,253

(22) Filed: Jul. 18, 2013

(51) Int. Cl. G06F 21/31

(52) U.S. Cl. CPC G06F 21/31
USPC 726/19

(57) ABSTRACT

A system and a method for extending the sign-in process for accessing computer system is provided. The system and method allows construction of notices which contains prerequisite conditions to be fulfilled by the user along with the credentials for accessing the computer system. The system and the method further allow updation of the data provided by the user in data storage.

### BACKGROUND OF THE INVENTION

1. Field of the Invention

The present invention generally relates to a method and a system for signing into the computer systems, and particularly relates to extending of the process for signing into the computer systems by notifying the users with information and/or making the user's to fulfill prerequisite requirements before signing into the computer system.

2. Description of Related Art

In today's world when computer user's logs in into a computer, the process addresses only the authentication and access. In general, only after users pass the authentication and gain access to the computer, they start doing the necessary tasks for which the computer is required. Sometimes the users are required to use their computer to fulfill certain requirements but forget to do that for various reasons such as:

poor scheduling of the work, unawareness of the daily requirements, etc. Sometimes, daily requirements include providing certain information for legal or mandatory policies such as signing of wavier forms or consent. Sometimes, certain information or notifications need to be provided to users before they proceed with their tasks in the system. This creates a hassle within organization to keep track and constantly remind the users to complete the required tasks or make sure users see the notifications.

Therefore, there is a need of a system and a method for making it mandatory for the user of a computer system to fulfill prerequisite requirements. Further, the system and the method should allow updation of the prerequisite requirements for each user.

### SUMMARY OF THE INVENTION

In accordance with the teachings of the present invention, a system and a method for extending the sign-in process for accessing computer systems is provided.

An object of the present invention is to provide a system and a method for extending the sign-in process for accessing computer systems through constructing notice which are required to be filled, reviewed and/or acknowledged along with the credentials for signing into the computer system.

Another object of the present invention is to provide a system and a method to update the data provided by the user for fulfilling the prerequisite requirements, acknowledgements or marking of information that was provided to the user in data storage.

Another object of the present invention is to provide a system and a method to provide predetermined number of chances to correct fulfillment of prerequisite requirements upon user's failure of correct response.

Another object of the present invention is to provide a system and a method to allow updation of the prerequisite requirements or notifications constructed in the notice regularly.

### BRIEF DESCRIPTION OF DRAWINGS

FIG. 1 illustrates a flowchart of a method for extending the sign-in process for accessing computer systems in accordance with a preferred embodiment of the present invention;

FIG. 2 illustrates a block diagram of a system for extending the sign-in process for accessing computer systems in accordance with a preferred embodiment of the present invention;

FIG. 3 illustrates a schematic diagram of a system in accordance with a preferred embodiment of the present invention;

FIG. 4 illustrates a schematic diagram of a system in accordance with another preferred embodiment of the present invention; and

FIG. 5 illustrates a schematic diagram of a system in accordance with another preferred embodiment of the present invention.

### DETAILED DESCRIPTION OF DRAWINGS

While this technology is illustrated and described in a preferred embodiment, a system and method for extending the sign-in process for accessing computer systems may be described in many different configurations, forms and various methods, without deviating from the scope of present invention. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

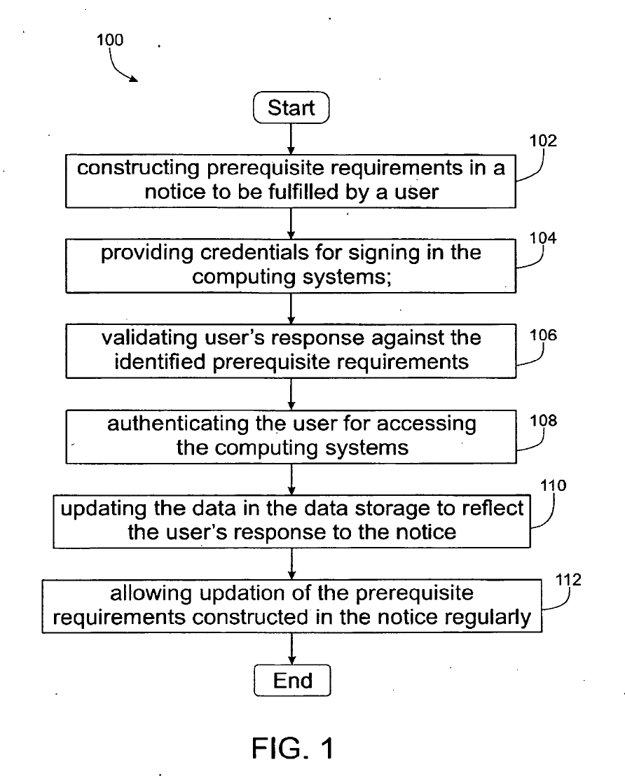

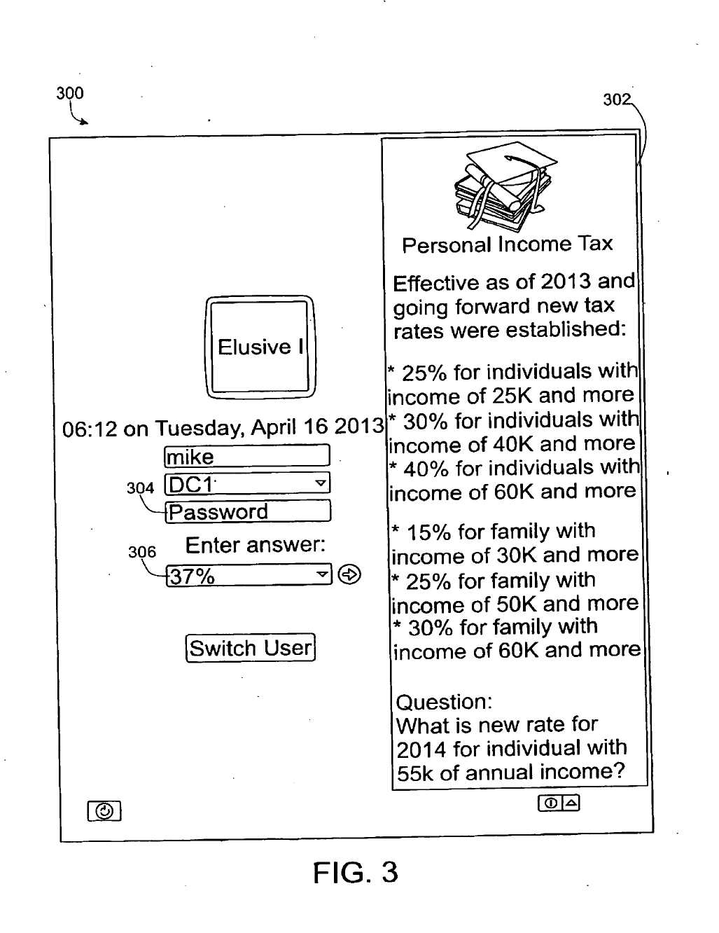

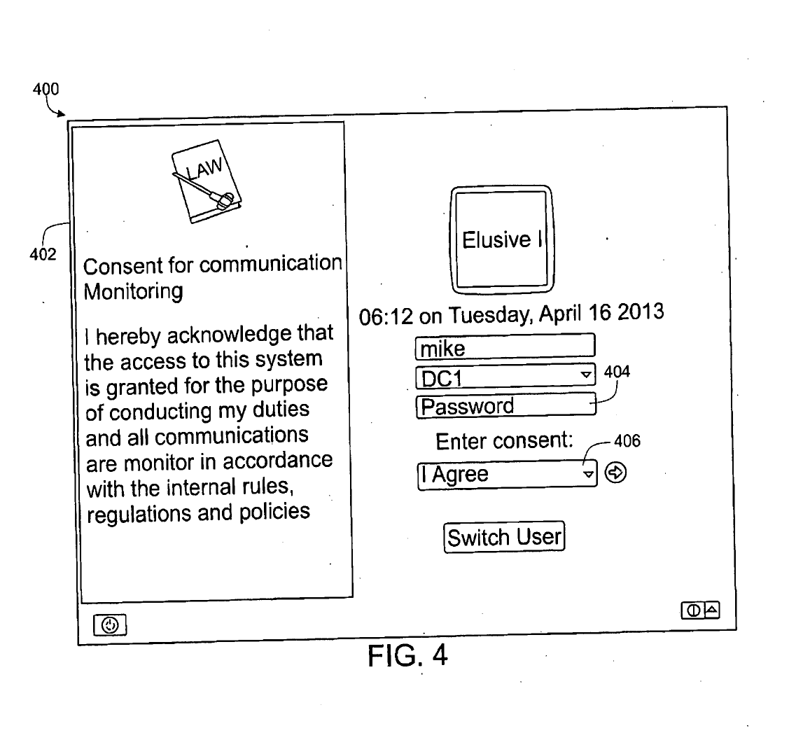

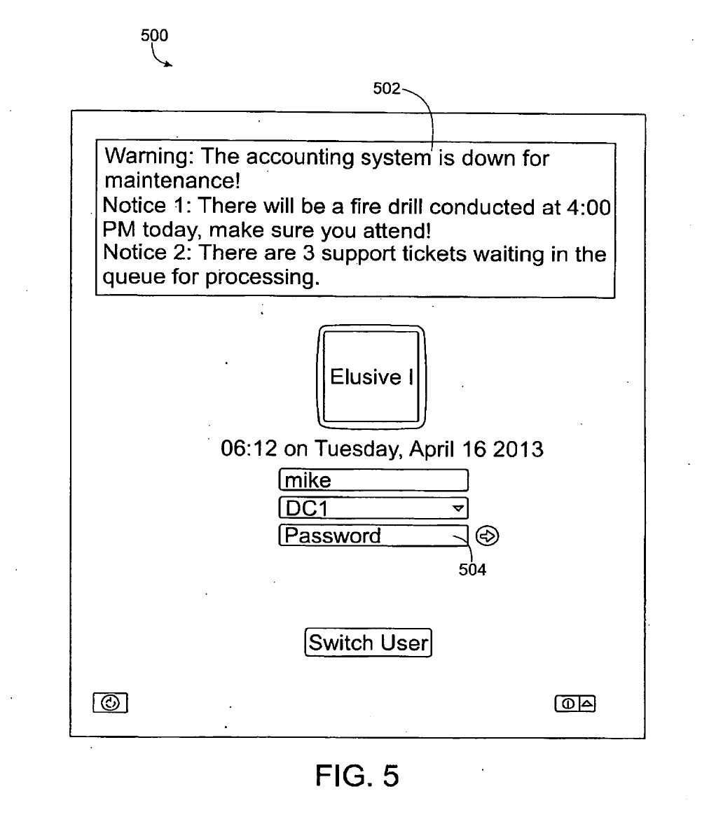

FIG. 1 illustrates a flowchart of a method 100 for extending the sign-in process for accessing computer systems in accordance with a preferred embodiment of the present invention. The method 100 initiates with a step 102 to construct prerequisite requirements in a notice to be fulfilled by a user. In a preferred embodiment of the present invention, the user is allowed to access the computer system only if the prerequisite requirements are fulfilled in a notice by the user. The notice is explained in detailed in conjunction with FIG. 3, FIG. 4 and FIG. 5 of the present invention.

In another preferred embodiment of the present invention, the user may be given a grace to fulfill prerequisite requirements. For example, the period may be of a particular period such as hours, days, weeks or months. Another example of the grace would be number of times granting access to the computer system without fulfilling the prerequisite requirements.

The step 102 is then followed by a step 104 to provide credentials for signing into the computer systems. The user is made to provide credentials for signing into the computer systems. The examples of credentials include but not limited to username, userID, password etc. It will be readily apparent to those skilled in the art that herein various credentials may be used without deviating from the scope of the invention.

In a preferred embodiment of the present invention, the step 104 is then followed by a step 106 to validate user's response against the identified prerequisite requirements. The computer system then verifies the prerequisite requirements provided in the notice by the user.

In a preferred embodiment of the present invention, the step 106 is then followed by a step 108 to authenticate the user for accessing the computer system. The user is authenticated by the authentication mechanism of the computer system.

In another preferred embodiment of the present invention, the step 108 is then followed by a step 110 to update the data stored in data storage to reflect the user's response to the notice. The examples of data storage includes but not limited to databases and files located on any devices virtual or physical.

In another preferred embodiment of the present invention, the step 110 is then followed by a step 112 to allow regular updation of the prerequisite requirements constructed in the notice. The computer system further allows the notice to get updated regularly to construct different requirements.

In another preferred embodiment of the present invention, the method 100 further includes a step of providing predetermined number of chances to correct fulfillment of prerequisite requirements upon user's failure of correct response.

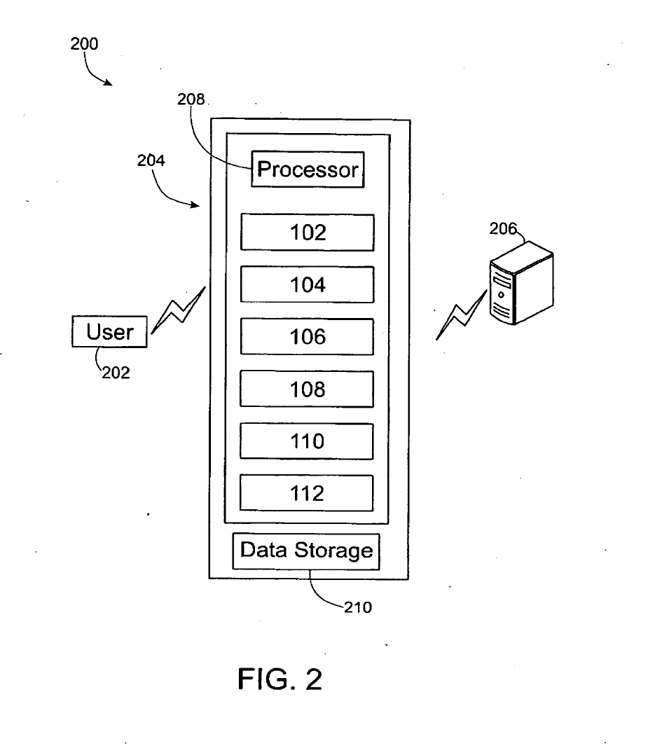

FIG. 2 illustrates a block diagram of a network environment 200. The network environment 200 includes a user 202, a system 204 and a network 206. The system 204 is operated by the user 202 and may communicate through the network 206 with other computer systems (servers). The network may be either intranet or internet. The system 204 is connected to the server 206. The system 204 includes a processor 208 and a data storage 210. In a preferred embodiment of the present invention, the processor 208 executes the step 102, 104, 106 and 108. The steps from 102 to 108 are explained in detailed in conjunction with FIG. 1 of the present invention. The data storage 210 may either be located locally or on the remote server. The data storage 210 stores the data provided by the user 202 for fulfilling the prerequisite requirements.

In another preferred embodiment of the present invention, the processor 208 further executes the step 110 and the step 112. The step 110 and the step 112 are explained in conjunction with FIG. 1 of the present invention.

In another preferred embodiment of the present invention, the processor 208 further executes a step of providing predetermined number of chances to correct fulfillment of prerequisite requirements upon user's failure of correct response.

FIG. 3 illustrates a schematic diagram of a system 300 in accordance with a preferred embodiment of the present invention. In an exemplary embodiment of the present invention, the notice 302 includes a question that is required to be answered by the user. The question asked in the notice is ‘What is new rate for 2014 for individual with 55K of annual income?’ The user provides the answer for the above question as a mandatory step to log in the computer system. The supporting material to the question provided to the user is ‘Effective as of 2013 and going forward new tax rates were established:
*25% for individuals with income of 25K and more
*30% for individuals with income of 40K and more
*40% for individuals with income of 60K and more
*15% for family with income of 30K and more
*25% for family with income of 50K and more
*30% for family with income of 60K and more

The user provides credentials 304 to access the computer system. The user provides answer to the notice 302 in answer box 306. The user is allowed to access the computer system only if the user fulfilled the prerequisite requirements (question asked in notice).

FIG. 4 illustrates a schematic diagram of a system 400 in accordance with another preferred embodiment of the present invention. In another exemplary embodiment of the present invention, the notice 402 may require a response from the user on ‘consent for communication monitoring’ as a prerequisite requirement. As shown in FIG. 4, the response given by the user is ‘I hereby acknowledge that the access to this system is granted for the purpose of conducting my duties and all communication are monitor in accordance with the internal rules, regulations and policies’. Further on providing the required information, the user provides the credential 404 to access the computer system. The user selects the option of ‘I Agree’ and provides its consent in the enter consent box 406 for the notice 402. The notice 402 may be updated daily through the computer system and thus required information may be received from the users regularly without any delay.

FIG. 5 illustrates a schematic diagram of a system 500 in accordance with another preferred embodiment of the present invention. The notice 502 includes information that is provided to the user. As shown, an example of the notice is as follows:
‘Warning: The accounting system is down for maintenance!
Notice 1: There will be a fire drill conducted at 4:00 PM today, make sure you attend!
Notice 2: There are 3 support tickets waiting in the queue for processing.’
The information is made available to the user as a notification.

In another preferred embodiment of the present invention, the steps of the invention as explained in FIG. 2 of the present invention may be performed on a single computer without the requirement of any network.

It will be readily apparent to those skilled in the art that various modifications of the notice may be created without deviating from the scope of the invention. Examples of computer systems include but not limited to Linux, UNIX, Windows, Mac OS X, Solaris, FreeBSD.

The present invention offers various advantages. The present invention allows preparation of notices that contain those prerequisite requirements which are mandatory and are required to be fulfilled. The information which is essential and required is available through notices. Thus, it would help to avoid organizations to keep track and constantly remind the users to complete their required tasks.

1. A method for extending the sign-in process for accessing computer systems, said method comprising the steps of:
constructing prerequisite requirements in a notice to be fulfilled by a user;
providing credentials for signing into the computer systems;
validating user's response against the identified prerequisite requirements; and
authenticating the user for accessing the computer systems.

2. The system according to claim 1 wherein in the processor is further configured to execute the step of updating the data in the data storage to reflect the user's response to the notice.

3. The method according to claim 1 further comprising the step of providing predetermined number of chances to correct fulfillment of prerequisite requirements upon user's failure of correct response.

4. The method according to claim 1 further includes a step of allowing updation of the prerequisite requirements constructed in the notice regularly.

5. A system for customizing the sign-in process for accessing computer systems, said system comprising:
a processor; and
a data storage coupled to said processor, said data storage to store instructions executable by said processor, wherein said processor is configured to process the steps of:
constructing prerequisite requirements in a notice to be fulfilled by a user;
providing credentials for signing in the computer systems;
validating user's response against the identified prerequisite requirements; and
authenticating the user for accessing the computer systems.

6. The system according to claim 5 wherein in the processor is further configured to execute the step of updating the data in the data storage to reflect the user's response to the notice.

7. The system according to claim 5 wherein in the processor is further configured to execute the step of providing predetermined number of chances to correct fulfillment of prerequisite requirements upon user's failure of correct response.

8. The system according to claim 6 wherein the processor is further configured to allow updation of the prerequisite requirements constructed in the notice regularly.
